(19) United States
(12) Patent Application Publication
(10) Pub. No.: US 2012/0178009 A1
(43) Pub. Date: Jul. 12, 2012

(54) FUEL CELL SEALING CONFIGURATION

(76) Inventors: Robert A. Love, Bloomfield, CT (US); Jeffrey G. Lake, Vernon, CT (US)

(21) Appl. No.: 13/496,332

(22) PCT Filed: Nov. 9, 2009
(86) PCT No.: PCT/US09/63701

§ 371 Date: Mar. 15, 2012

(51) Int. Cl. H01M 2/14; H01M 8/04

(52) U.S. Cl. 429/434; 429/508; 429/450

(57) ABSTRACT

A fuel cell plate includes a structure having opposing sides bounded by a periphery providing at least one edge. Gas flow channels are arranged on the one side and arranged within a perimeter that is spaced inboard from the periphery to provide a first gasket surface between the perimeter and the periphery. Inlet and outlet flow channels are arranged on the other side and extend to the periphery and are configured to provide gas at the at least one edge. Holes extend through the structure and fluidly interconnect the inlet and outlet flow channels to the gas flow channels. In one example, the fuel cell plate is a water transport plate in a fuel cell having external manifolds that supply fluid to the plate.

### BACKGROUND

This disclosure relates to a sealing configuration for a fuel cell having external manifolds.

A fuel cell includes multiple cells arranged in a cell stack assembly. In one type of fuel cell, each cell includes a membrane electrode assembly (MEA) arranged between an anode and a cathode. The anode and cathode include passages that respectively carry oxidant and reactant to the MEA to produce electricity (and water as a byproduct). In one type of arrangement, the passages are provided in porous water transport plates that permit the water to pass through the plate.

Heat is generated during fuel cell operation. Consequently, coolant passages are provided in the anode and/or cathode to remove heat in some types of cell stack assemblies. In one type of fuel cell, the oxidant, reactant and coolant are fluidly communicated to and from the anode and cathode using external manifolds. In the case of external manifolds, the passages in the anode and cathode water transport plates are routed from one edge of the plate to another edge to allow fluids to flow between the external manifolds. Typically, discretely placed gasket seals are arranged at the interface between the adjoining plates and the MEA to maintain separation of the oxidant and reactant and minimize leakage from the cell stack assembly. Some gaskets may be configured in an undesirable manner that adversely affects fuel cell operation and/or efficiency.

### SUMMARY

A fuel cell plate is disclosed that includes a structure having opposing sides bounded by a periphery providing at least one edge. Gas flow channels are arranged on the one side and arranged within a perimeter that is spaced inboard from the periphery to provide a first gasket surface between the perimeter and the periphery. Inlet and outlet flow channels are arranged on the other side and extend to the periphery and are configured to provide gas at the at least one edge. Holes extend through the structure and fluidly interconnect the inlet and outlet flow channels to the gas flow channels. In one example, the fuel cell plate is a water transport plate in a fuel cell having external manifolds that supply fluid to the plate.

### BRIEF DESCRIPTION OF THE DRAWINGS

The disclosure can be further understood by reference to the following detailed description when considered in connection with the accompanying drawings wherein:

FIG. 1A is a highly schematic view of a fuel cell with inlet and outlet manifolds.

FIG. 1B is a highly schematic view of a cell stack assembly for the fuel cell shown in FIG. 1A.

FIG. 2A is a highly schematic end view of a portion of the cell stack assembly shown in FIG. 1B illustrating a subgasket and various other gaskets.

FIG. 2B is a cross-sectional view taken along line 2B-2B of FIG. 2A with a portion of a manifold.

FIG. 3 is an elevational view of a first side of a cathode water transport plate.

FIG. 4 is an elevational view of a second side of the cathode water transport plate shown in FIG. 3.

FIG. 5 is an elevational view of a first side of an anode water transport plate.

FIG. 6 is an elevational view of a second side of the anode water transport plate shown in FIG. 5.

FIG. 7 is an enlarged view of the second side taken in area 7 of FIG. 6.

FIG. 8 is an enlarged view of the first side taken in area 8 of FIG. 5.

### DETAILED DESCRIPTION

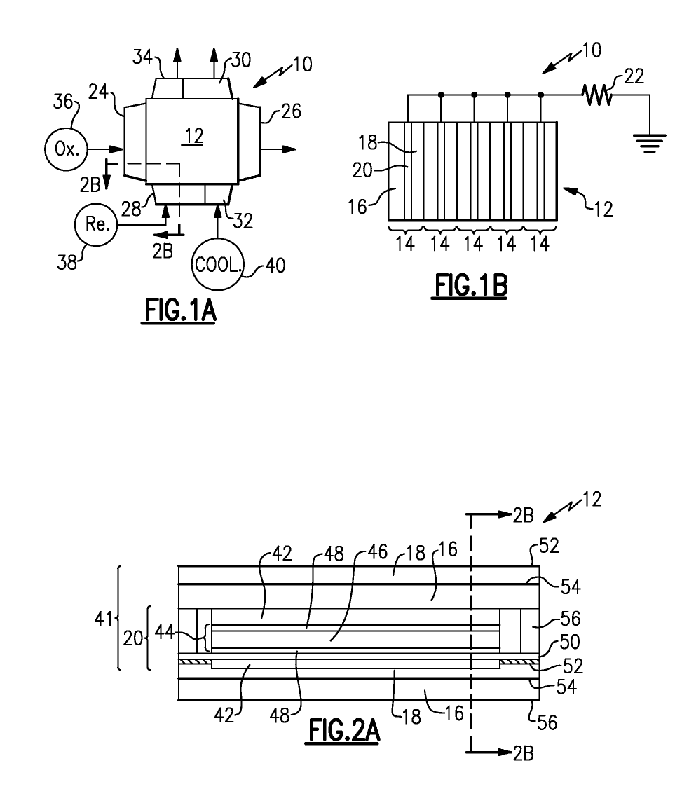

FIGS. 1A and 1B depict a fuel cell 10 in a highly schematic fashion. The fuel cell 10 includes a cell stack assembly 12 having multiple cells 14 arranged adjacent to one another. Each cell 14 includes an anode 16 and a cathode 18 arranged on either side of a unitized electrode assembly 20. The unitized electrode assemblies 20 produced electricity to power a load 22 in response to oxidant and reactant, respectively provided by the anode 16 and cathode 18, interacting with one another in a known fashion.

Fluids are introduced to and expelled from the cell stack assembly 12 using various manifolds. An oxidant source 36 supplies an oxidant, such as hydrogen, to an oxidant inlet manifold 24. Oxidant flows through flow channels in the anode 16 and is collected at an oxidant outlet manifold 26. A reactant source 38 provides a reactant, such as air, to a reactant inlet manifold 28. The reactant flows through flow channels in the cathode 18 and is collected by a reactant outlet manifold 30. The cell stack assembly 12 generates heat as the oxidant and reactant interact with one another. As a result, a coolant source 40 may be used to provide a coolant, such as water, to cool the fuel cell 10. Coolant is supplied through a coolant inlet manifold 32 and flows through flow channels in the anode 16 and/or cathode 18 and is collected by the coolant outlet manifold 34. In the example shown, the reactant inlet manifold 28 and coolant inlet manifold 32 are integrated with one another. The reactant outlet manifold 30 and coolant outlet manifold 34 are also integrated with one another.

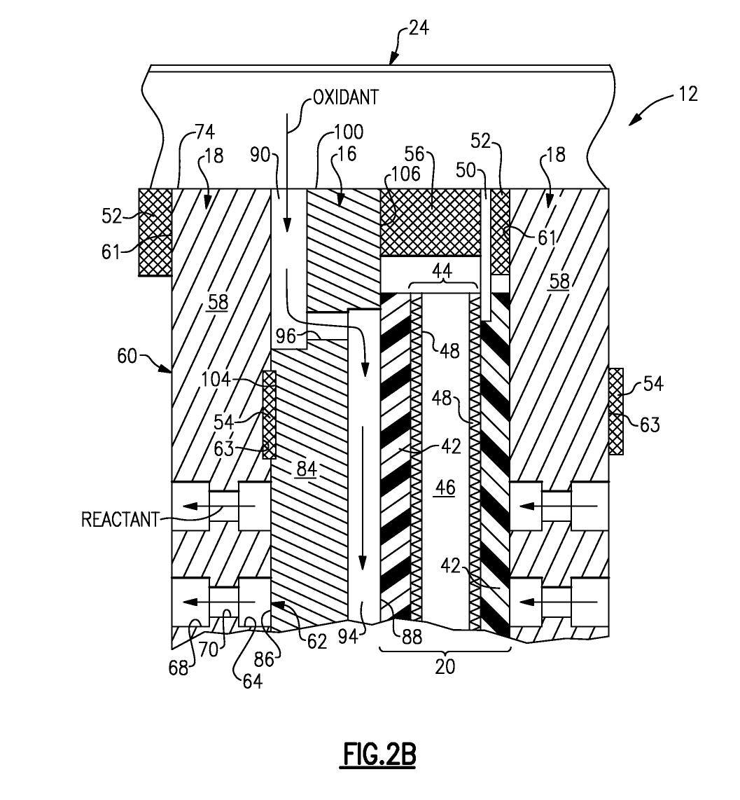

A portion of the cell stack assembly 12 is shown in more detail in FIG. 2A. For manufacturing purposes, a unitized cell assembly 41 may be provided by a cathode 18 and an anode 16 secured to one another and the unitized electrode assembly 20, as schematically illustrated. The unitized electrode assembly 20 includes a membrane electrode assembly 44 having a proton exchange member 46 arranged between catalysts 48. A gas diffusion layer 42 is arranged on one side of the membrane electrode assembly 44. A subgasket 50 is arranged between the other side of the membrane electrode assembly 44 and another gas diffusion layer 42. The perimeter of the subgasket 50 extends to the perimeter of the cell stack assembly 12 while the periphery of the unitized electrode assembly 20 is arranged inboard from the perimeter of the cell stack assembly 12 to reduce the amount of relatively expensive unitized electrode assembly materials needed to provide a cell 14.

First, second and third gaskets 52, 54, 56 are used as seals between the anode 16, cathode 18 and subgasket 50. Unlike other prior art gasket arrangements, the first, second and third gaskets 52, 54, 56 do not extend across the flow channels provided in the anode 16 and cathode 18.

The arrangement of the first, second and third gaskets 52, 54, 56 may be better appreciated by reference to FIG. 2B. As shown in FIG. 1A, the cell stack assembly 12 is configured for use with external manifold assemblies to communicate the fluids to and from the cell stack assembly 12. The anode 16 and cathode 18 must be sealed relative to one another to maintain separation of the oxidant and reactant.

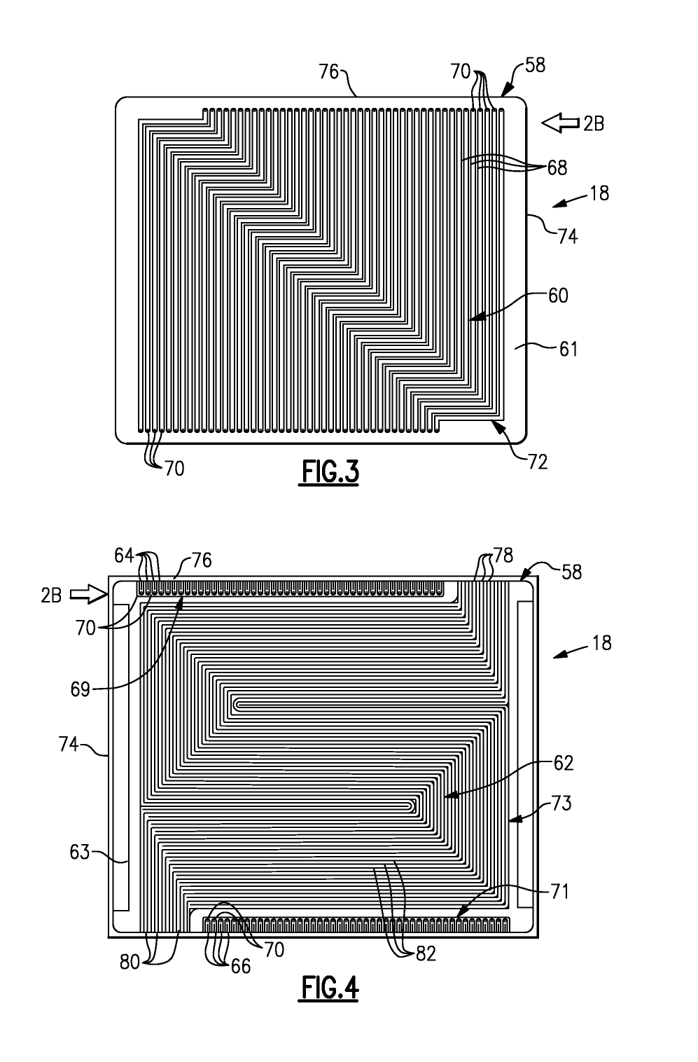

With reference to FIGS. 2B, 3 and 4, the cathode 18 is shown in more detail. The cathode 18 is constructed from a porous cathode water transport plate 58, for example. The cathode water transport plate 58 includes spaced apart first and second sides 60, 62 extending to a periphery having edges. Reactant inlet channels 64 extend to an edge 76 for communication with the reactant inlet manifold 28 (FIG. 1A). Edge 74 faces the oxidant inlet manifold 24 (FIG. 2B). The second side 62 also includes reactant outlet channels 66 extending to an edge opposite the edge 76. Reactant flow channels 68 are arranged on the first side 60. The reactant inlet and outlet channels 64, 66, which are remote from one another, communicate with the reactant flow channels 68 through holes 70 that fluidly interconnect the channels to one another. The holes 68 are sized to regulate the flow of reactant through the cathode 18.

In the example cell stack assembly 12, the second side 62 includes coolant inlet and outlet channels 78, 80 in fluid communication with the coolant flow channels 82 arranged on the second side 62. The coolant inlet and outlet channels 78, 80 extend to opposing edges of the cathode water transport plate 58 remote from one another and are respectively in fluid communication with the coolant inlet and outlet manifolds 32, 34 (FIG. 1A). Additionally or alternatively, the coolant channels 78, 80, 82 may be provided on the anode water transport plate 84. The cathode and anode water transport plates 58, 84 are porous and permit the flow of water between opposing sides of the plates.

The reactant flow channels 68 provide a reactant flow channel perimeter 72 arranged inboard from the edges of the cathode water transport plate 58. A first gasket surface 61 is provided on the first side 60 between the reactant flow channel perimeter 72 and the edges of the cathode water transport plate 58 at its outer periphery. Inlet and outlet perimeters 69, 71 are respectively provided about the reactant inlet and outlet channels 64, 66. In the example, the inlet and outlet perimeters 69, 71 extend to the nearby edges. The coolant inlet and outlet flow channels and coolant flow channel 78, 80, 82 provide a coolant perimeter 73. A second gasket surface 63 is arranged between the inlet and outlet perimeters 69, 71 and the coolant perimeters 73 and the cathode water transport plate 58 edges at its periphery on the second side 62.

The first gasket 52 is provided on the first gasket surface 61 such that the first gasket 52 does not overlap the reactant flow channels 68. The first gasket 52 seals against the subgasket 50. The second gasket 54 is arranged on the second gasket surface 63 such that the second gasket 54 does not overlap the reactant inlet and outlet channels 64, 66 and the coolant inlet and outlet flow channels and coolant flow channels 78, 80, 82.

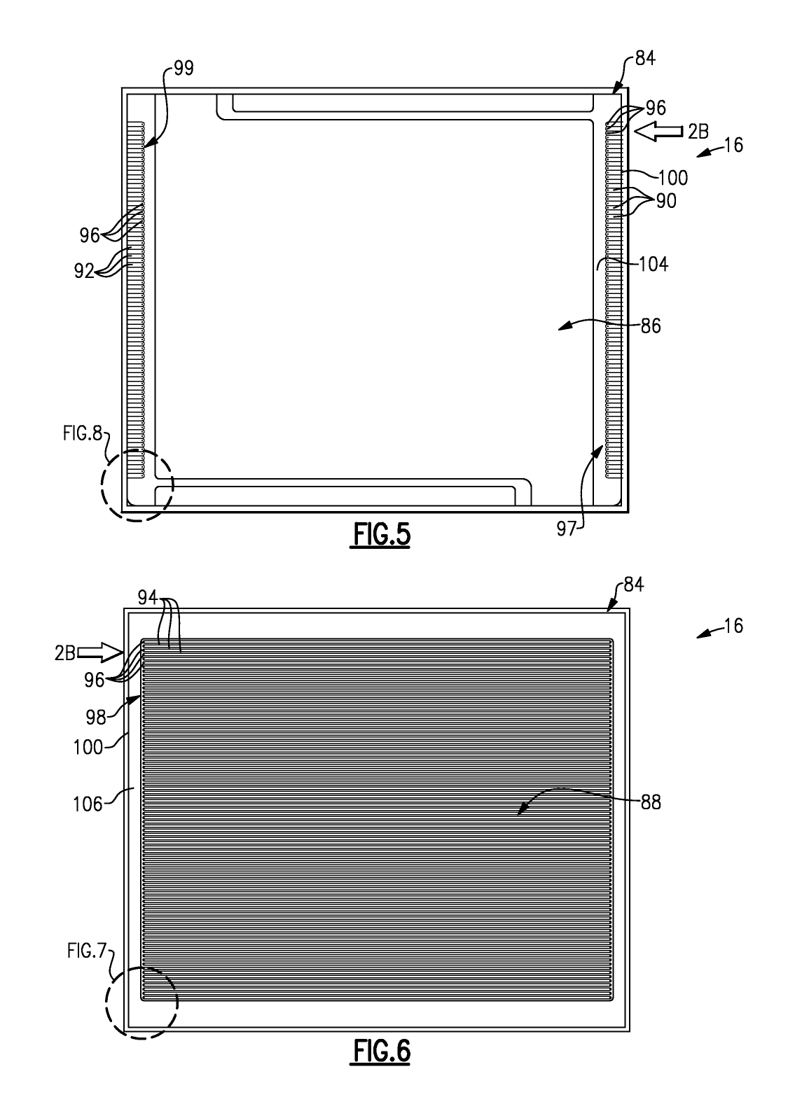

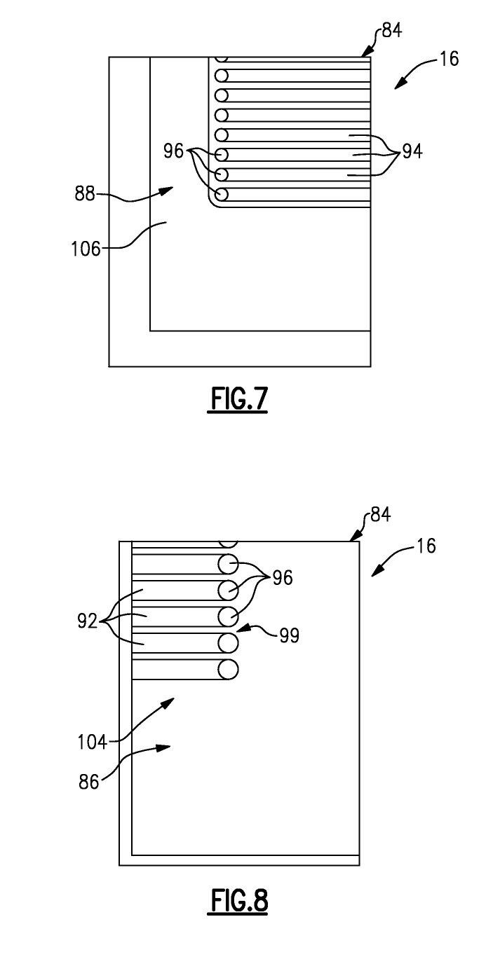

With reference to FIGS. 2B and 5-8, the anode 16 is shown in more detail. The anode 16 is constructed from a porous anode water transport plate 84, for example. The anode water transport plate 84 includes spaced apart first and second sides 86, 88 extending to a periphery having edges. Oxidant inlet channels 90 extend to an edge 100 for communication with the oxidant inlet manifold 24 (FIG. 1A). The second side 88 also includes oxidant outlet channels 92 extending to an edge opposite the edge 100. Oxidant flow channels 94 are arranged on the first side 86. The oxidant inlet and outlet channels 90, 92, which are remote from one another, communicate with the oxidant flow channels 94 through holes 96 that fluidly interconnect the channels to one another. The holes 96 (shown in more detail in FIGS. 7 and 8) are sized to regulate the flow of oxidant through the anode 16.

The oxidant flow channels 94 provide an oxidant flow channel perimeter 98 arranged inboard from the edges of the anode water transport plate 84. A first gasket surface 104 is provided on the first side 86 between the oxidant flow channel perimeter 98 and the edges of the anode water transport plate 84 at its outer periphery. Inlet and outlet perimeters 97, 99 are respectively provided about the reactant oxidant inlet and outlet channels 90 92. In the example, the inlet and outlet perimeters 97, 99 extend to the nearby edges. A second gasket surface 106 is arranged between the inlet and outlet perimeters 97, 99 and the anode water transport plate 84 edges at its periphery on the second side 88.

The second gasket 54 is provided on the first gasket surface 104 such that the second gasket 54 does not overlap the oxidant inlet and outlet channels 90, 92. The second gasket 54 seals against the second gasket surface 63 on the second side 62 of the cathode water transport plate 58. The third gasket 56 is arranged on the second gasket surface 106 such that the third gasket 56 does not overlap the oxidant flow channels 94. The third gasket 56 seals against the subgasket 50.

Although a preferred embodiment has been disclosed, a worker of ordinary skill in this art would recognize that certain modifications would come within the scope of the claims. For that reason, the following claims should be studied to determine their true scope and content.

What is claimed is:

1. A fuel cell plate comprising:
a structure having opposing sides bounded by a periphery providing at least one edge, gas flow channels arranged on the one side and arranged within a perimeter that is spaced inboard from the periphery to provide a first gasket surface between the perimeter and the periphery, inlet and outlet channels arranged on other side and extending to the periphery and configured to provide gas at the at least one edge, holes extending through the structure and fluidly interconnecting the inlet and outlet channels to the gas flow channels.

2. The fuel cell plate according to claim 1, wherein the inlet and outlet channels are arranged on portions of the other side that are remote from one another, the inlet and outlet channels extending to opposite edges of the periphery and respectively providing inlet and outlet flow perimeters, a second gasket surface arranged on the other side adjacent to the inlet and outlet flow perimeters.

3. The fuel cell plate according to claim 2, comprising coolant flow channels arranged on the other side adjacent to the second gasket surface, the coolant flow channels having inlet and outlet channels extending to the periphery and configure to communicate coolant at the at least one edge.

4. The fuel cell plate according to claim 1, wherein the structure is a porous water transport plate.

5. The fuel cell plate according to claim 4, wherein the structure is an anode water transport plate.

6. The fuel cell plate according to claim 4, wherein the structure is a cathode water transport plate.

7. A fuel cell comprising:
a plate having opposing sides bounded by a periphery providing at least one edge, gas flow channels arranged on the one side and arranged within a perimeter that is spaced inboard from the periphery to provide a first gasket surface between the perimeter and the periphery, inlet and outlet channels arranged on other side and extending to the periphery and configured to provide gas at the at least one edge, holes extending through the plate and fluidly interconnecting the inlet and outlet channels to the gas flow channels; and
a manifold arranged external to the plate over the at least one edge and in fluid communication with the flow channels.

8. The fuel cell according to claim 7, comprising a first gasket supported on the first gasket surface, the gasket in a non-overlapping relationship with the gas flow channels.

9. The fuel cell according to claim 8, comprising a structure adjacent to the plate and sealed relative to the plate by the first gasket.

10. The fuel cell according to claim 9, wherein the plate is one of an anode water transport plate and a cathode water transport plate, and the structure is one of an electrode assembly and the other of the anode water transport plate and the cathode water transport plate.

11. The fuel cell according to claim 10, wherein the electrode assembly includes a membrane electrode assembly arranged between gas diffusion layers, the membrane electrode assembly and gas diffusion layers providing an electrode assembly periphery, the electrode assembly including a subgasket extending outward from the electrode periphery, and the first gasket sealing against the subgasket.

12. The fuel cell according to claim 7, wherein the inlet and outlet channels are arranged on portions of the other side that are remote from one another, the inlet and outlet channels extending to opposite edges of the periphery and respectively providing inlet and outlet perimeters, a second gasket surface arranged on the other side adjacent to the inlet and outlet perimeters, a second gasket supported on the second gasket surface, the second gasket in a non-overlapping relationship with the inlet and outlet flow channels.

13. The fuel cell according to claim 12, comprising a structure adjacent to the plate and sealed relative to the plate by the second gasket.

14. The fuel cell according to claim 13, wherein the plate is one of an anode water transport plate and a cathode water transport plate, and the structure is the other of the anode water transport plate and the cathode water transport plate.

15. The fuel cell according to claim 13, comprising coolant flow channels arranged on the other side adjacent to the second gasket surface, the coolant flow channels having inlet and outlet channels extending to the periphery and configure to communicate coolant at the at least one edge.
